(19) United States
(12) Patent Application Publication
(10) Pub. No.: US 2009/0094791 A1
(43) Pub. Date: Apr. 16, 2009

(54) COMBINATION HANDLE AND EXTENSION HANDLE KIT FOR CLEANING IMPLEMENTS

(76) Inventor: Dan Blom, Paramount, CA (US)

Correspondence Address: MARC E. HANKIN, ESQ., 11414 THURSTON CIRCLE, LOS ANGELES, CA, 90049, US

(21) Appl. No.: 11/871,503

(22) Filed: Oct. 12, 2007

(51) Int. Cl. B25G 1/04

(52) U.S. Cl. 16/427; 16/429

(57) ABSTRACT

Various embodiments of this invention are directed towards a kit for a combination cleaning implement handle and extension handle kit that may be detachably connected to an implement holder. Various embodiments of the invention feature a pin lock that is configured in a sloped, oval shape such that the extension handle may be easily attached to implement handles of various types.

### RELATED PATENT APPLICATIONS

This patent application is related to invention disclosed by the United States Patent Application for “Detatchable Extension Handle” by Dan Blom, U.S. patent application Ser. No. 11/766,789, which is incorporated herein by reference.

### FIELD OF INVENTION

Various embodiments of this invention relate, generally, to systems for cleaning devices; more particularly, to cleaning implement handle kits, which allow various cleaning implements and handles to be detachably attached to one another.

### BACKGROUND

Conventional cleaning implement handles utilize a pole and implement attachment system in order to allow user to re-attachably connect cleaning implements to the pole. The related arts systems, however, suffer from several shortcomings and Various related art systems disclose such systems; for example: U.S. Pat. No. 1,483,435 to Hammer, U.S. Pat. No. 3,425,756, U.S. Pat. No. 4,466,377, U.S. Pat. No. 6,378,400 to Bogli, and U.S. Patent Application No. 2003/0135950 to Dove.

U.S. Pat. No. 1,483,435 to Hammer, for example, discloses a detachable handle that attaches to another implement by an aperture on the handle that engages with a fastener. Then, in order to remove Hammer's detachable handle, one loosens the fastener and releases the handle from the implement. In this manner, the handle may be added to and removed from other implements. The device, however, requires the use of additional tools, such as a screw driver or wrench in order to loosen the fastener, which may be undesirable in many circumstances.

Another such mechanism is disclosed by U.S. Pat. No. 3,425,756 to Hubbard. Hubbard's patent discloses a detachable extension handle that is also extensible. The extension handle uses a pin lock in order to connect the extension handle to an implement. The pin lock in Hubbard's device comprises a round symmetrical and generally cylindrically shaped button that is spring-loaded, such that when depressed, the button returns to its natural position. Like other pin locks, the button engages with an aperture in order to connect the extension handle to an implement. Hubbard improves upon other devices in the art by featuring a plurality of apertures at different distances along the implement. Thus, by selecting a given aperture, the user may select the desired length of the extension.

Like other pin lock mechanisms, however, the Hubbard's mechanism suffers from many shortcomings, making it undesirable to use in certain applications. First, in order to attach the extension handle to an implement, a user must depress the button, thereby requiring additional effort. The implement cannot be attached easily or with one hand. Also, in cases where the implement, such as a mop or paint brush, may be dirty or contaminated, it is often times undesirable to hold the implement because the dirt or contamination is transferred to the user's hands. Also, the circular shape of the pin lock is not conducive to easy attachment to and removal from the implement.

Another such mechanism is disclosed by U.S. Pat. No. 4,466,377 to Kolb et al. Kolb discloses a device for fastening handles to implements by a button activated locking insert. An extension is attached to a handle by, first, inserting the implement to an opening in the handle. Within the handle, a leaf spring engages with a hole in the implement in order to lock the handle onto the implement. The mechanism also features a push-button that is depressed from the outside of the handle in order to release the leaf spring and the implement from the handle.

A similar such mechanism is disclosed by U.S. Pat. No. 6,378,400 to Bogli. Bogli's patent discloses a detachable handle socket ratchet system that allows the user to change handles to suit the needs of the user. The coupling system, that attaches the handle to the ratchet, comprises a hinged and spring-loaded retaining pin at the handle that engages with a groove at the ratchet. The retaining pin disclosed by Bogli improves upon other related art systems by being generally sloped towards the distal end of the lever. In order to remove the handle from the ratchet, a button is pressed by the user, depressing the retaining pin from the groove, and allowing the handle to be removed.

Another such mechanism is disclosed by U.S. Patent Application No. 2003/0135950 to Dove. Dove's patent application discloses a mechanism for connecting a paint brush handle to an extension pole by a spring button device. Like the above patents, however, Dove fails to disclose a mechanism whereby the extension handle may easily be attached to the implement without the necessity of depressing the push-button. Further, like the above patents, Dove fails to disclose the use of an oval-shaped button, such that the extension is more easily attached to and removed from the implement.

In order to address the shortcomings of these and other related art systems, there remains a long felt need in the art for a combination handle and extension handle kit for cleaning implements, which allows various handles, extension handles, and cleaning implements to be easily attached and re-attached to one another.

### SUMMARY OF THE INVENTION

Various embodiments of the invention are directed towards overcoming the shortcomings of the above and other related art systems by disclosing a combination cleaning implement handle and extension handle kit. Various embodiments of the invention comprise a kit with numerous parts that allow the cleaning implement handle to be variably attached and re-attached the cleaning implements.

Various embodiments of the invention comprise: one or more implement holders; a relatively short implement handle; and a relatively long implement handle that is telescoping and extendible.

Various embodiments of the invention further comprise an attachment system which may be used to attach the implement handles to one or more implement holders. In various embodiments of the invention, the attachment system comprises a pin lock system. The pin lock, in various embodiments of the invention, features a novel shape. First, the top side of the pin features a slope that angles toward the edge of the distal end of the extension handle. This sloped top configuration allows the pin lock mechanism to engage with the aperture of the implement handle without the need for the user to manually depress the pin. Also, the pin, in various embodiments of the invention, features a novel oval or rounded edge shape. The oval shaped pin allows the pin to engage with the aperture with a minimal effort by the user. Similarly, in various embodiments of the invention that use a generally rectangular-shaped pin that features rounded edges, the rounded edges allow the pin to smoothly, and relatively effortlessly, engage with the aperture. In this manner, the novel configuration of the pin allows the extension handle to be more easily coupled to the implement handle than other prior art devices.

The pin lock mechanism further features a spring mechanism that presses the pin outwards. In various embodiments of the invention, the spring mechanism comprises a pin that is located within the extension handle and serves to apply pressure on the pin upwards. The use of a novel shape for the pin and the spring allows the pin to engage with the aperture in order that the implement handle may be removably connected to the extension handle.

It remains within the contemplation of the invention that it to be used with varying types of cleaning implements. Implement handles of varying lengths, materials, and types remain within the contemplation of the invention. Telescoping handles of varying types also may be used with the various embodiments of the invention. Also, the principles of the invention may be practiced with various cleaning implements. The principles of the invention may, for example, be practiced with household, industrial, and construction implements and their related extension handles, including but not limited to: brooms, mops, specialty mops, window squeegees, floor squeegees, window cleaners, floor sponges, window sponges, trowels, dust pans, dust mops, scrapers, bulb changers, dusters, feather dusters, brushes, carpet sweepers, and further such devices known in the art.

### BRIEF DESCRIPTION OF THE DRAWINGS

FIG. 1 is an illustration from a perspective view of the various parts of the combination handle kit for cleaning implements in various embodiments of the invention.

FIG. 2 is an illustration from a perspective view of the various parts of the combination handle kit for cleaning implements in various embodiments of the invention.

FIG. 3 is an illustration from a perspective view of engagement mechanism between a short implement handle and a long implement handle while disengaged.

FIG. 4 is an illustration from a perspective view of engagement mechanism between a short implement handle and a long implement handle while engaged.

FIG. 5 is an illustration from a side view of a cleaning implement holder in various embodiments of the invention.

FIG. 6 is an illustration from a side view of a cleaning implement holder in various embodiments of the invention.

FIG. 7 is an illustration from a perspective view of the combination handle kit for cleaning implements while being utilized by a user.

FIG. 8 is an illustration from a perspective view of the combination handle kit for cleaning implements in various embodiments of the invention.

FIG. 9 is an illustration from a perspective view of the combination handle kit for cleaning implements while being utilized by a user.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention. Various embodiments of the invention remain useable in tandem or combination of one another.

In the following description, certain terminology is used to describe certain features of one or more embodiments of the invention. For instance, “implement handle” refers to any of the various household, industrial, and construction handles; “implement holder” refers to any of the various devices for detachably connecting mop head, mop pad, broom head, mop, specialty mop, window squeegee, floor squeegee, window cleaner, floor sponge, window sponge, trowel, dust pan, dust mop, scraper, bulb changer, duster, feather duster, brush, carpet sweeper, and further such devices known in the art.

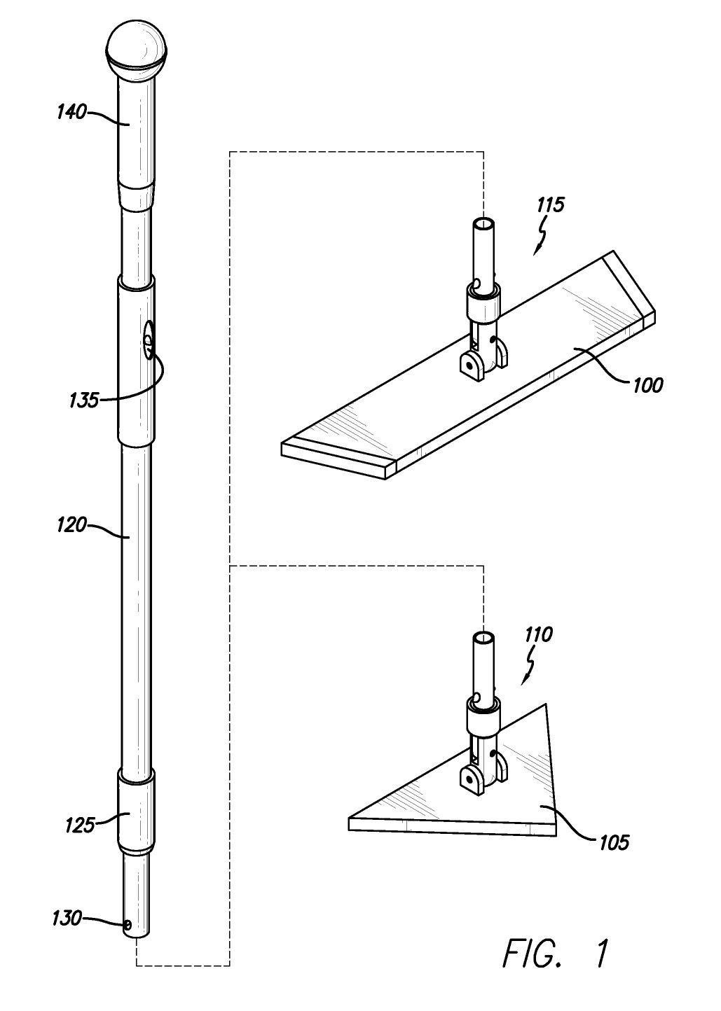

FIG. 1 is an illustration from a perspective view of the various parts of the combination handle kit for cleaning implements in various embodiments of the invention. A first cleaning implement holder 100 is illustrated and the first cleaning implement holder 100 attaching a stem 115, which features one or more swivel joints and an attachment system for attaching the first cleaning implement holder to one or more implement handles. Also, a second cleaning implement holder 105 is illustrated and the second cleaning implement holder 105 attaches a stem 110, which features one or more swivel joints and an attachment system for attaching the second cleaning implement holder to one or more implement handles. The second cleaning implement holder 105 is configured in a triangle shape in order to allow easier cleaning of corners. A first cleaning implement handle 140 is illustrated while attached to a second cleaning implement handle 120. The second cleaning implement handle features a telescoping system 125. At the distal end of the second cleaning implement handle, an attachment system 130 is featured, which allows the second cleaning implement handle to be alternatively attached to one of the cleaning implement holders. The first cleaning implement handle 120 and second cleaning implement handle 140 may be attached to one another by an attachment system 135, which allows them to combine to form a longer unitary cleaning implement handle.

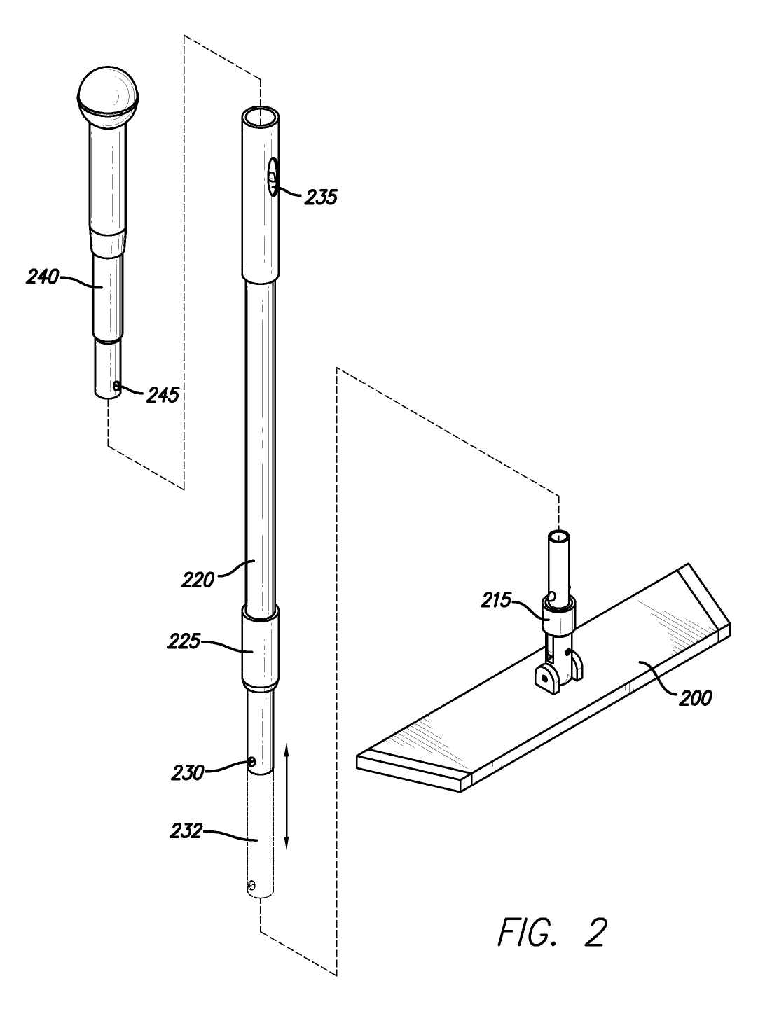

FIG. 2 is an illustration from a perspective view of the various parts of the combination handle kit for cleaning implements in various embodiments of the invention, while disassembled. A first cleaning implement holder 100 is illustrated and the first cleaning implement holder 200 attaching a stem 215, which features one or more swivel joints and an attachment system for attaching the first cleaning implement holder to one or more implement handles. A first cleaning implement handle 240 is illustrated while attached to a second cleaning implement handle 220. The second cleaning implement handle features a telescoping system 225. The second cleaning implement handle 220 may be adjusted to an extended position 232. At the distal end of the second cleaning implement handle, an attachment system 230 is featured, which allows the second cleaning implement handle to be alternatively attached to one of the cleaning implement holders. The first cleaning implement handle 220 and second cleaning implement handle 240 may be attached to one another by an attachment system, which allows them to combine to form a longer unitary cleaning implement handle. The first cleaning implement handle 220 features an attachment system 245 at its distal end, which is configured to mate with an attachment system 325 at the proximal end of the second implement handle 220.

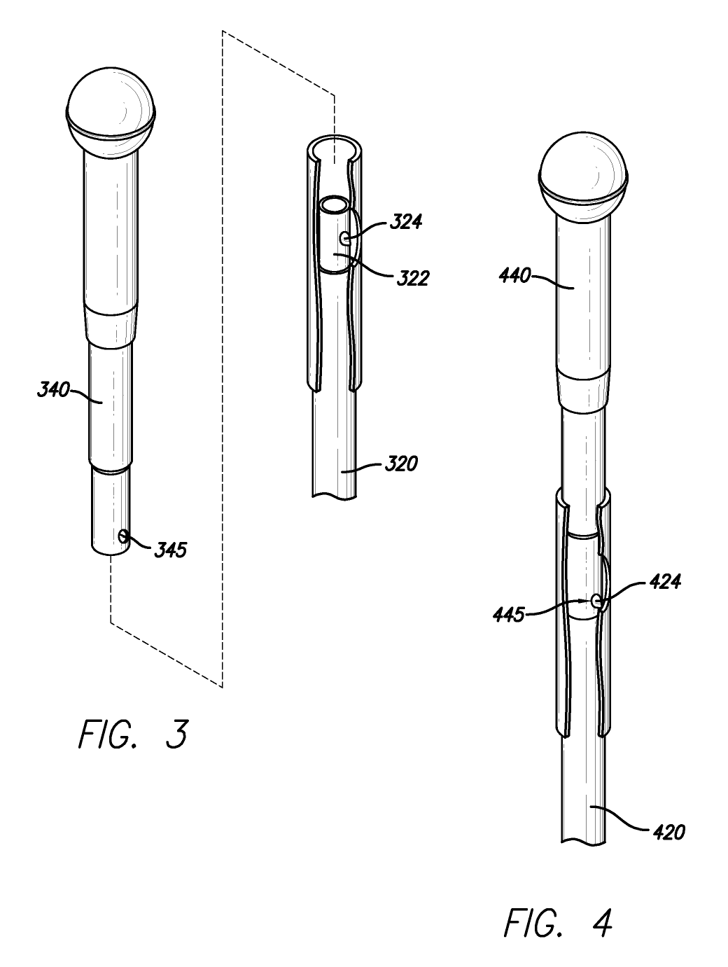

FIG. 3 is an illustration from a perspective view of engagement mechanism between a short implement handle and a long implement handle while disengaged. A first cleaning implement handle 340 features an attachment system 345 at its distal end, which is configured to engage with an attachment system 324 at the proximal end of the second implement handle 320. The proximal end of the second implement handle 320 features a reduced diameter section 322, which allows the first implement handle 340 and second implement handle 320 to be matingly attached to one another.

FIG. 4 is an illustration from a perspective view of engagement mechanism between a short implement handle and a long implement handle while engaged. A first cleaning implement handle 440 features an attachment system 445 at its distal end, which is configured to engage with an attachment system 424 at the proximal end of the second implement handle 420.

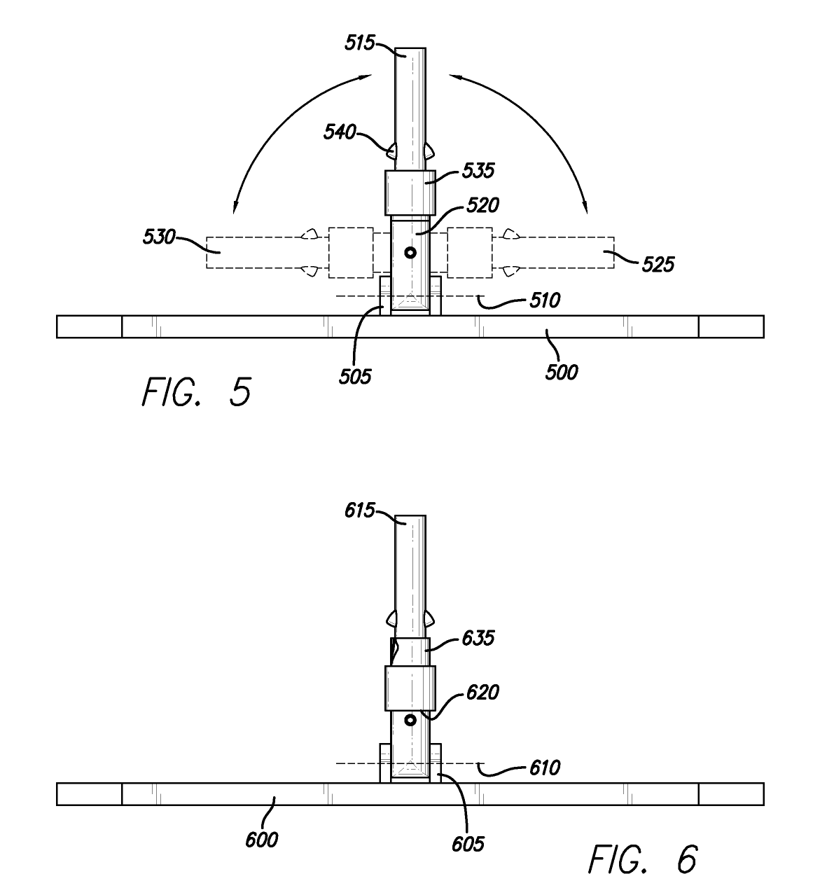

FIG. 5 is an illustration from a side view of a cleaning implement holder in various embodiments of the invention. A cleaning implement holder 500 features a stem 515, with a first swivel joint 505 and a second swivel joint 520. The first swivel joint 505 allows the stem 515 to rotate along a longitudinal axis 510. The second swivel joint 520 allows the stem 515 to rotate along an axis approximately orthogonal to the axis 505 of the first swivel joint 505. The second swivel joint 520 allows the stem 515 to rotate approximately one-hundred and eighty degrees between 525 and 530. The second swivel joint 520 features a latch 535, which, when lowered, prevents the rotation of the second swivel joint 520. The latch 535 is illustrated in the raised position. The stem 515 features an attachment system 540, allowing the stem 515 to be attached to one or more cleaning implement handles.

FIG. 6 is an illustration from a side view of a cleaning implement holder in various embodiments of the invention. A cleaning implement holder 600 features a stem 615, with a first swivel joint 605 and a second swivel joint 620. The first swivel joint 605 allows the stem 615 to rotate along a longitudinal axis 610. The second swivel joint 620 allows the stem 615 to rotate along an axis approximately orthogonal to the axis 605 of the first swivel joint 605. The second swivel joint 620 features a latch 635, which, when lowered, prevents the rotation of the second swivel joint 620. The latch 635 is illustrated in the lowered position, which prevents the stem 615 from rotating.

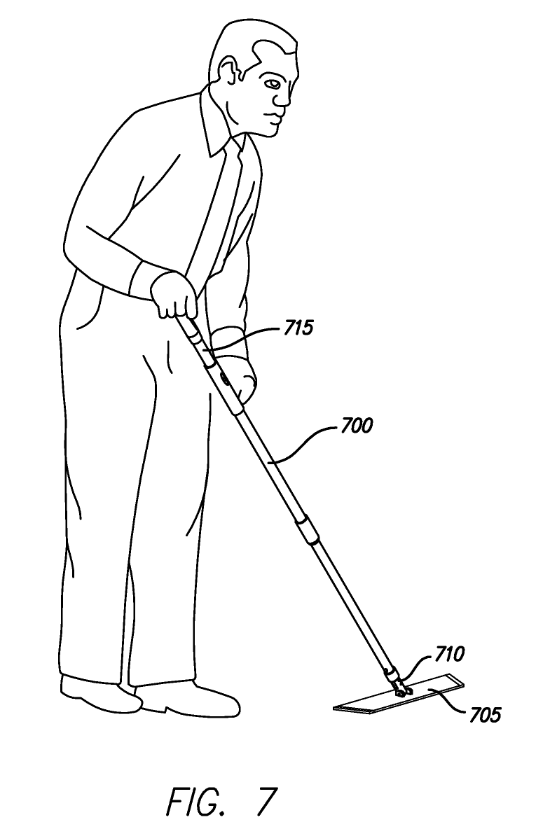

FIG. 7 is an illustration from a perspective view of the combination handle kit for cleaning implements while being utilized by a user. A second cleaning implement handle 700 is illustrated while attaching the stem 710 and cleaning implement holder 705. A first cleaning implement handle 715 is attached to the second cleaning implement handle, allowing the pole to be extended for greater comfort of the user.

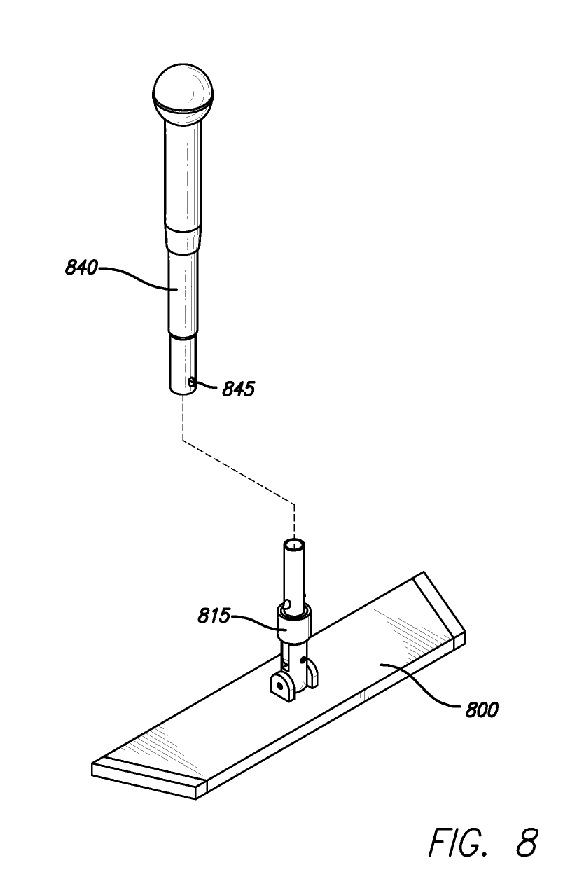

FIG. 8 is an illustration from a perspective view of the combination handle kit for cleaning implements in various embodiments of the invention. A shorter cleaning implement handle 800 features attachment system 845 at its distal end, which allows it to be detachable connected to the stem 815 of a cleaning implement holder 800. When combined, this allows a short holder variation of the invention to be utilized.

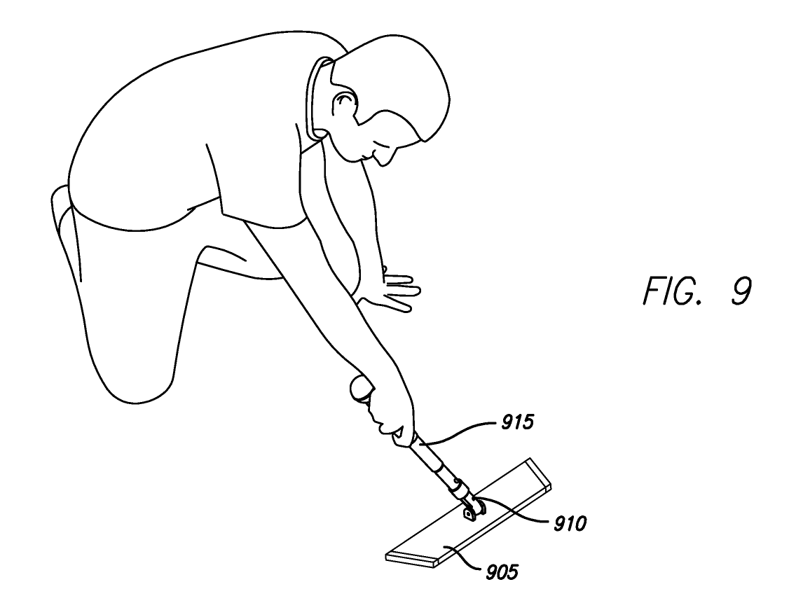

FIG. 9 is an illustration from a perspective view of the combination handle kit for cleaning implements while being utilized by a user. A shorter cleaning implement handle 900 is attached to the pivoting stem 910 to the cleaning implement holder 905. In this manner, the kit allows a short device and a long device to be utilized.

What is claimed is:

1. A combination handle and extension handle kit for cleaning implements, comprising,
one or more cleaning implement holders, said one or more cleaning implement holders comprising a bottom surface and a top surface, said bottom surface configured detachably connect cleaning implements and said top surface being configured to attach a first swivel joint, said first swivel joint pivoting said cleaning implement holder in a first direction and attaching a second swivel joint, said second swivel joint pivoting said first swivel joint in a second direction, said second direction being orthogonal to said first direction, and having a proximal end, said proximal end featuring an attachment system,
a first implement handle, said first implement handle having a proximal end and a distal end and being shorter in length than a second implement handle, said first implement handle featuring an attachment system at its distal end, said attachment system configured to attach said first implement handle to said one or more cleaning implement holders,
a second implement handle, said second implement handle having a proximal end and a distal end and being longer in length than said first implement handle, said second implement handle featuring an attachment system at its distal end, said attachment system configured to attach said second implement handle to said one or more cleaning implement holders, and
said attachment system comprising, an opening at the distal end of said implement handles for the insertion of said cleaning implement holder into the generally hollow portion of said distal end of said implement handle, and featuring an aperture, said aperture comprising an opening in said distal end of said implement handles that releasably engages with a pin and said aperture being configured to circumscribe said pin when engaged, said pin being attached to the proximal end of said cleaning implement holder and said pin protruding axially from said distal end of extension handle, featuring a spring that applies pressure to said pin, and said pin generally having a top and side surfaces, the top surface of said pin being generally slanted downwards toward the distal end of said extension handle such that the protrusion of said pin is minimal at the portion of the pin that is closest to the distal end of said extension handle, and the side surfaces of said pin being generally oval-like in shape, and said spring being configured to pressure said pin axially outwards.

2. A combination handle and extension handle kit for cleaning implements according to claim 1, wherein said second implement handle comprises a telescoping implement handle.

3. A combination handle and extension handle kit for cleaning implements according to claim 1, wherein said second swivel joint comprises a latch that is configured to defeat the swivel capabilities of said second swivel joint.

4. A combination handle and extension handle kit for cleaning implements according to claim 1, wherein the cross sectional shape of said first implement handle and said second implement handle is circular.

5. A combination handle and extension handle kit for cleaning implements according to claim 1, wherein the implement holder supports an implement selected from the following group of implements: brooms, mops, specialty mops, window squeegees, floor squeegees, window cleaners, floor sponges, window sponges, trowels, dust pans, dust mops, scrapers, bulb changers, dusters, feather dusters, brushes, and carpet sweepers.

6. A combination handle and extension handle kit for cleaning implements according to claim 1, wherein said first implement handle and said second implement handle further comprise a handgrip.

7. A combination handle and extension handle kit for cleaning implements, comprising,
one or more cleaning implement holders, said one or more cleaning implement holders comprising a bottom surface and a top surface, said bottom surface configured detachably connect cleaning implements and said top surface being configured to attach a first swivel joint, said first swivel joint pivoting said cleaning implement holder in a first direction and attaching a second swivel joint, said second swivel joint pivoting said first swivel joint in a second direction, said second direction being orthogonal to said first direction, and having a proximal end, said proximal end featuring an attachment system,
a first implement handle, said first implement handle having a proximal end and a distal end and being shorter in length than a second implement handle, said first implement handle featuring an attachment system at its distal end, said attachment system configured to attach said first implement handle to said one or more cleaning implement holders,
a second implement handle, said second implement handle having a proximal end and a distal end and being longer in length than said first implement handle, said second implement handle featuring an attachment system at its distal end, said attachment system configured to attach said second implement handle to said one or more cleaning implement holders, and
said attachment system being configured to detachably connect said one or more implement holders to said first implement handle and said second implement handle.

8. A combination handle and extension handle kit for cleaning implements according to claim 7, wherein said attachment system comprises, an opening at the distal end of said implement handles for the insertion of said cleaning implement holder into the generally hollow portion of said distal end of said implement handle, and featuring an aperture, said aperture comprising an opening in said distal end of said implement handles that releasably engages with a pin and said aperture being configured to circumscribe said pin when engaged, said pin being attached to the proximal end of said cleaning implement holder and said pin protruding axially from said distal end of extension handle, featuring a spring that applies pressure to said pin, and said pin generally having a top and side surfaces, the top surface of said pin being generally slanted downwards toward the distal end of said extension handle such that the protrusion of said pin is minimal at the portion of the pin that is closest to the distal end of said extension handle, and the side surfaces of said pin being generally oval-like in shape, and said spring being configured to pressure said pin axially outwards.

9. A combination handle and extension handle kit for cleaning implements according to claim 7, wherein said second implement handle comprises a telescoping implement handle.

10. A combination handle and extension handle kit for cleaning implements according to claim 7, wherein said second swivel joint comprises a latch that is configured to defeat the swivel capabilities of said second swivel joint.

11. A combination handle and extension handle kit for cleaning implements according to claim 8, wherein said second swivel joint comprises a latch that is configured to defeat the swivel capabilities of said second swivel joint.

12. A combination handle and extension handle kit for cleaning implements according to claim 7, wherein the cross sectional shape of said first implement handle and said second implement handle is circular.

13. A combination handle and extension handle kit for cleaning implements according to claim 7, wherein the implement holder supports an implement selected from the following group of implements: brooms, mops, specialty mops, window squeegees, floor squeegees, window cleaners, floor sponges, window sponges, trowels, dust pans, dust mops, scrapers, bulb changers, dusters, feather dusters, brushes, and carpet sweepers.

14. A combination handle and extension handle kit for cleaning implements according to claim 7, wherein said first implement handle and said second implement handle further comprise a handgrip.
